(19) United States
(12) Patent Application Publication
(10) Pub. No.: US 2004/0054560 A1
(43) Pub. Date: Mar. 18, 2004

(54) Method for managing evidence of a product or service reservation and device therefor

(76) Inventors: Philippe Levionnais, Caen (FR); Jean-Claude Pailles, Epron (FR)

Correspondence Address: GARDNER CARTON & DOUGLAS LLP, 191 N. WACKER DRIVE, SUITE 3700, CHICAGO, IL, 60606, US

(21) Appl. No.: 10/415,698

(22) PCT Filed: Oct. 30, 2001
(86) PCT No.: PCT/FR01/03368

(30) Foreign Application Priority Data
Oct. 31, 2000 (FR) 00/13991

(51) Int. Cl. G06F 17/60

(52) U.S. Cl. 705/5; 705/1

(57) ABSTRACT

The invention proposes, firstly, a method of managing a proof of the reservation by a customer (C) of a product or a service, the method consisting in a reservation management unit (RMU) sending (300) a portable object (MP) of the customer (C) reservation data which is stored in a memory of the portable object (MP) to serve as proof of the reservation, and, secondly, a system for implementing the method.

The present invention relates to a method and a system for managing a proof of reservation of a product or a service.

The type of proof envisaged here is that supplied by a provider of products or services (hereinafter called the provider) to a person (hereinafter called the customer) seeking to acquire a product from the provider or to obtain the benefit of a service that is provided by the provider, said product or service being predefined and possibly prepaid. The invention applies to the field of techniques for formalizing the sale of a product or a service that separate, firstly, the time at which the provider offers the product or the service to the customer, who accepts it, and usually pays for it, and, secondly, the later time at which the provider actually delivers the reserved product or actually provides the reserved service. Hereinafter the first time is called the reservation time and the second time is called the checking time, because it is at this latter time that it is necessary to check the validity of the reservation made by the customer in order to deliver the right product to the right customer or to provide the right service to the right customer.

Such proof conventionally takes the form of a written document such as a coupon, a voucher, a receipt, etc. that is handed over to the customer at the reservation time and that the customer must produce at the checking time in order to prove that he is the true recipient of the reserved product or the true beneficiary of the reserved service. The generic term “proof” employed herein designates any means of attesting to the reservation made by the customer. The customer usually pays the price of the product or the service at the reservation time, in which case the proof also attests to the payment for the product or the service. This is not essential, however, in that the customer does not necessarily have to pay for the product or the service at the reservation time. Payment can be effected when the product is delivered or when the service is provided, or at any other time.

The invention is described hereinafter in the context of its non-limiting application to the provision of a passenger transport service, such as a train service. The service is then identified by the following characteristics, among others: a train number, the scheduled departure and arrival dates and times, the details of a particular seat on the train, a level of comfort (first or second class, business class, etc.), smoking or non-smoking, a price, etc.

In the prior art, making a reservation for a journey is manifested in the printing out of a voucher (or ticket) in the form of a written document providing proof of the reservation. To obtain this voucher, the customer must physically go to a ticket window of an establishment of the provider or to a travel agent to carry out the necessary transactions. These include, successively, the customer specifying more or less precisely the characteristics of the required journey, an agent of the provider analyzing the requirement, the agent consulting a database containing information relating to journeys offered by the provider that are still available, the agent orally formulating an offer to make a reservation for a particular journey, the customer orally accepting the offered reservation, (usually) paying the price of the journey by any appropriate payment means, and, finally, the agent printing out a voucher that is handed over to the customer to provide proof of the reservation. The voucher is also referred to as a “ticket”. The ticket has the two-fold function of attesting to the reservation and, where applicable, also attesting to payment of the price of the journey. The characteristics of the journey for which the reservation has been made are usually printed on the voucher. From the contractual point of view, it is usually the handing over of the voucher to the customer that imposes on the provider the obligation to transport the customer in accordance with the specified characteristics of the journey for which the reservation has been made and on the customer the obligation to pay the price of the journey. From the practical point of view, it is the showing of the voucher by the customer, for example to a checking agent on the train, that enables the reservation to be checked when the provider provides the transport service to the benefit of the customer. To this end, the checking agent reads the characteristics of the journey printed on the voucher.

However, the use of a printed voucher is a nuisance for the user, as it obliges him to go to a ticket window of the provider to collect it. Moreover, if the characteristics of the journey for which a reservation has been made are changed, the user has to return to the ticket window of the provider to cancel the previous reservation, hand over the corresponding voucher, make a new reservation, and collect a new voucher. Also, the voucher may be lost of stolen, or the user may forget to take it with him on the day he needs it.

In the last few years new forms of transactions between providers and potential customers have been developed with a view to simplifying the procedures involved.

Customers are now offered the possibility of obtaining a voucher serving as proof of a reservation from an automatic ticket machine. The machine includes a keyboard or a touch-sensitive screen on which the customer enters the characteristics of the required journey, means for interrogating and managing the database, a screen for displaying information, validation and payment means, for example a bank card (smart card) reader, and a printer for printing out the voucher. The automatic ticket machine avoids the queues frequently encountered at ticket windows. However, customers must still go to a train station to make a reservation, since that is where these machines are generally located. Moreover, if the customer wishes to modify the characteristics of the journey for which a reservation has been made (for example to change the departure time or date), he still has to go to a ticket window of the provider, in particular to hand back the original voucher.

It has also become commonplace to be able to make a reservation by telephone or via a telecommunications network such as the Internet. The conversation between the customer and the agent of the provider is then a telephone conversation, rather than a face to face conversation at a ticket window, or is replaced by selection of the characteristics of the journey using a program running on a personal computer. Thus the customer no longer needs to go to a station or travel agent. However, this reservation method still entails the printing out of a voucher in the form of a written document, which the customer has to collect from the ticket window of the provider just before the train departs, quoting a reservation number previously communicated to the customer for this purpose.

An object of the present invention is to offer a satisfactory solution to some or all of the above-mentioned problems that are encountered in the prior art.

In accordance with the invention, the above object is achieved by a method of managing proof of reservation of a product or a service by a given customer, the method consisting in processing reservation information relating to said reserved product or service in a memory of a communicating portable object of the customer which includes communications means for exchanging messages with a reservation management unit, said reservation information serving as proof of the reservation.

The customer's portable object can be a mobile telephone, a pocket computer provided with communications means, or any other portable equipment provided with communications means.

Processing the reservation information includes writing, reading, modifying and/or deleting the information in the memory, and displaying and/or sending information read in the memory.

The method comprises successively, in a reservation mode, the steps of:

a) producing information defining a request to reserve a product or service;

b) the reservation management unit receiving a reservation request message containing said information defining the reservation request in respect of the product or service;

c) the reservation management unit sending the portable object of the customer a message confirming the reservation and containing reservation information relating to the reserved product or service; and

d) storing said reservation information in the memory of the portable object of the customer to serve as proof of the reservation.

Thus no voucher needs to be printed out in the form of a written document to provide proof of the reservation. That proof is provided by the presence of the reservation information in the memory of the customer's portable object. It can be checked by reading the reservation information in the memory of the portable object. In other words the proof of the reservation takes the form of reservation information coded numerically, and the memory of the portable object serves as the medium for the proof of reservation. A mobile telephone or a pocket computer, for example, are objects with which the customer tends not to be careless and from which, in principle, the customer is never separated. Thus the invention reduces the risk of the proof of the reservation being lost, stolen or left behind.

Furthermore, the fact that the proof of the reservation consists in reservation information stored in the memory of the portable object enables improved checking of the proof.

The method of managing a proof of the reservation of a product or a service by a particular customer includes, in a checking mode, the steps of:

m) in a preparatory phase, the reservation management unit sending a checking terminal availability information relating to a reserved product or service, which information is stored in a memory of said checking terminal; and

n) in a checking phase, comparing the availability information saved in the memory of the checking terminal to reservation information relating to a reserved product or service stored in the memory of the portable object of a customer or to data identifying a customer.

This way of checking the proof is better than the prior art methods in that it enables the checker to have access in advance to information relating to the reserved product or service, such as data identifying the customer entitled to the reservation.

The invention also proposes a system for implementing the above management method, said system comprising:

a reservation management unit, and

a communicating portable object of a customer having a memory and communications means for exchanging messages with the reservation management unit.

Moreover, the system includes a checking terminal, in particular for implementing a checking mode of the method as defined hereinabove, the terminal comprising:

a memory, and

first communications means for exchanging messages with the reservation management unit.

Other features and advantages of the invention will become more apparent on reading the following purely illustrative description in conjunction with the appended drawings, in which:

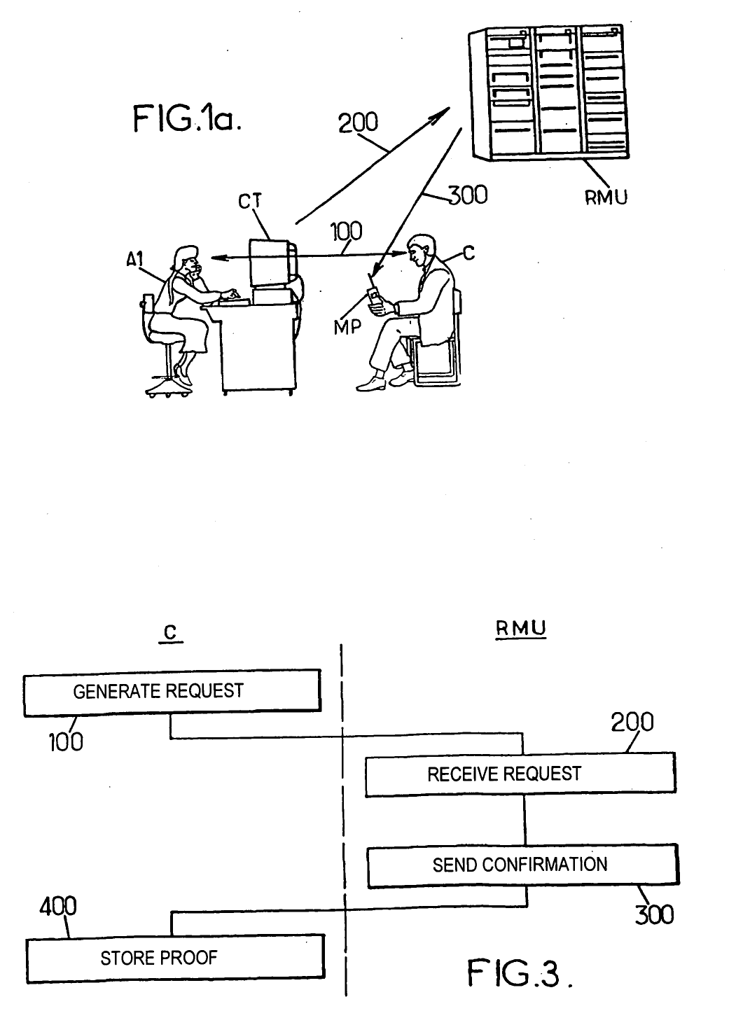

FIGS. 1a to 1c are diagrams of a system for implementing a management method of the invention, showing respective different examples of a reservation mode;

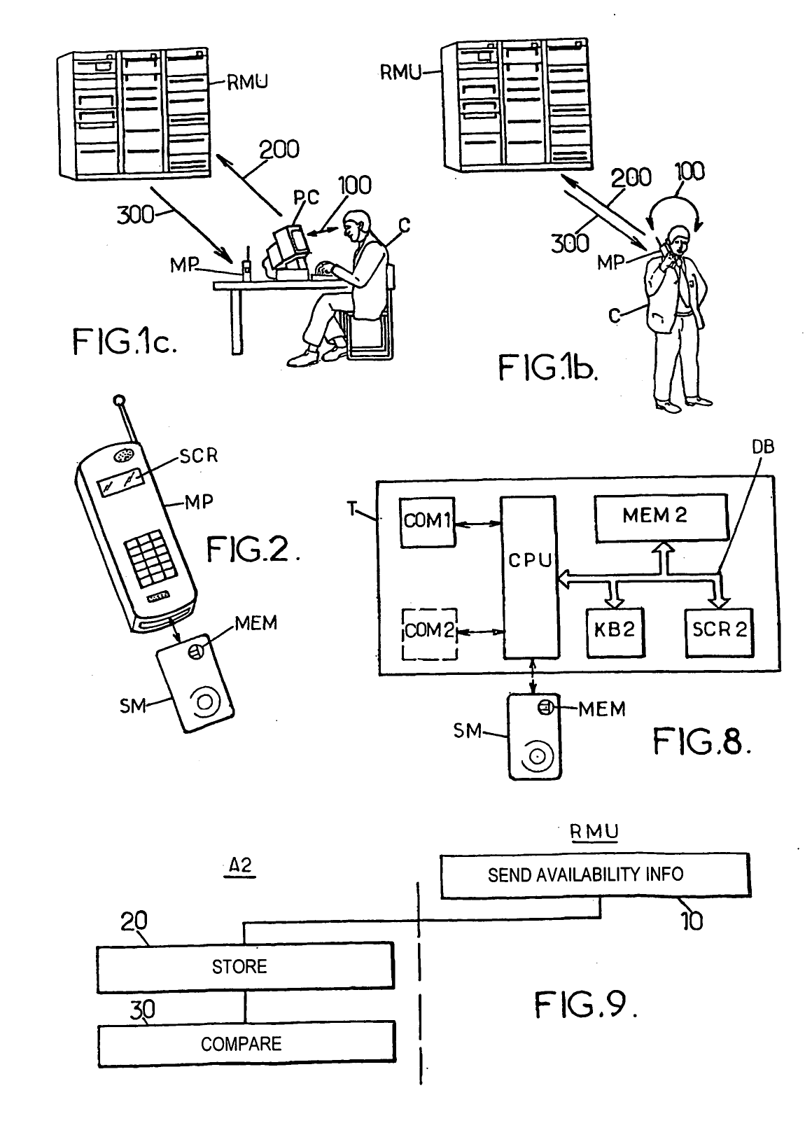

FIG. 2 is a diagram showing one example of a portable object of the invention;

FIG. 3 is a flowchart of the steps of a delivery mode of a management method of the invention;

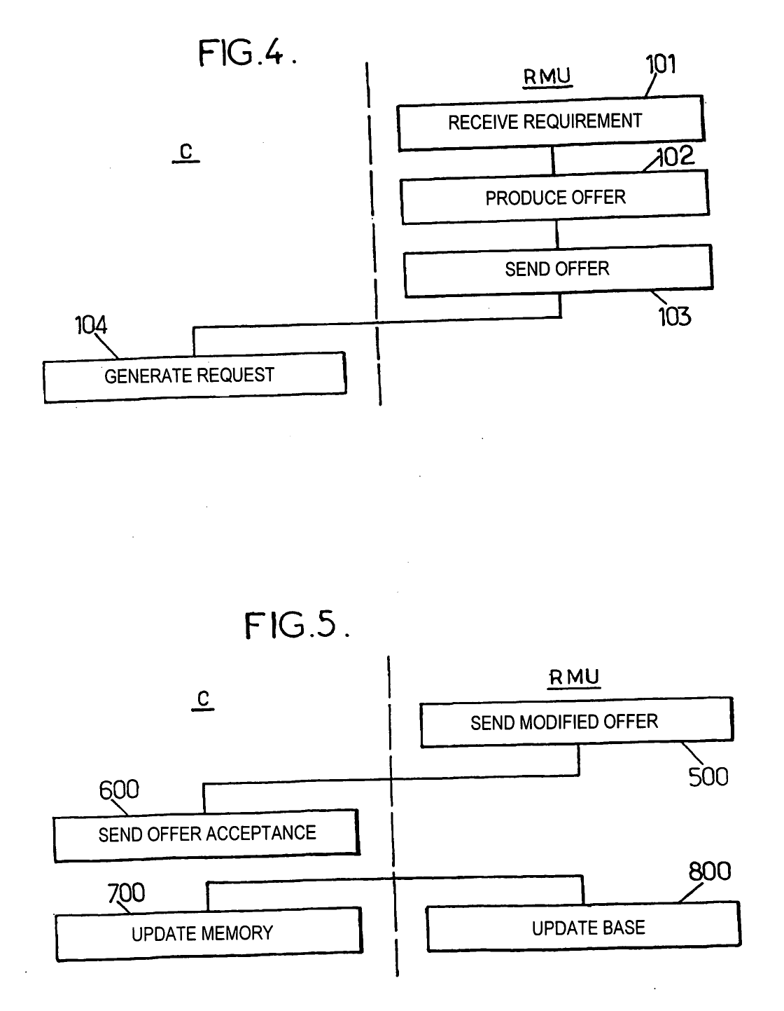

FIG. 4 is a flowchart of substeps of the first step of the method shown in the flowchart of FIG. 3;

FIG. 5 is a flowchart of complementary steps of a management method of the invention;

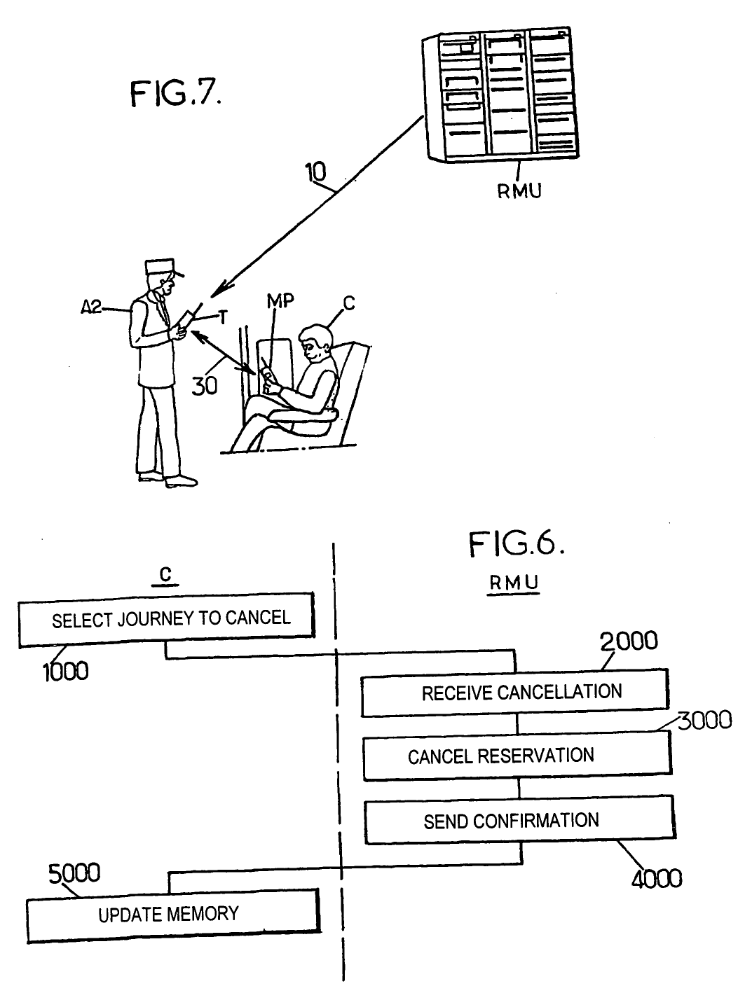

FIG. 6 is a diagram showing the steps of a cancellation mode of a management method of the invention;

FIG. 7 is a diagram showing a system for implementing a checking mode of a method of the invention;

FIG. 8 is a functional block diagram of a checking terminal of the system of FIG. 7; and

FIG. 9 is a flowchart of the steps of a control mode of a method of the invention.

Any item appearing in more than one figure is identified by the same reference number in all the figures in which it appears.

FIGS. 1a to 1c are diagrams of a system for implementing a method of managing a proof of the reservation of a product or a service, showing respective different examples of the use of a reservation mode.

The system includes a reservation management unit (RMU) in the form of a server, for example. Note that the RMU can be at a great distance from the location of a customer C when making a reservation for a journey. The system further includes a communicating portable object MP of the customer C. In the context of the present invention, the expression “communicating portable object” means a portable object including communications means enabling it to communicate with the RMU in particular. It could be a portable computer, a pocket computer, or more simply a mobile radio system terminal (mobile telephone). The following description relates to the non-limiting example of a mobile telephone of a mobile radio system such as the Global System for Mobile communications (GSM), which is a digital mobile radio system operating in the 900 MHz band.

The mobile phone (MP) has a non-volatile memory. In the preferred example, shown in FIG. 2, this memory is a removable memory such as the memory MEM of a smart card (SM), more particularly a subscriber identity module (SIM) card. This is a smart card to the ISO format or the micro-SIM format defined by the ETSI in the GSM standards. This kind of card is conventionally used in mobile phones to store data relating to the user.

In a manner that is also known in the art, a SIM card can store programs that can be executed by a microprocessor or a microcontroller in the mobile phone MP. In addition to internal processing (calculation, data management), as provided by any program, these programs can display information on a screen SCR of the mobile phone MP, receive information entered via the keys of the keyboard KB of the mobile phone MP pressed by the customer C, and send or receive a message in the format of the Short Message Service (SMS) associated with the mobile radio system. At present, this service enables short alphanumeric messages to be sent and received over long distances, for example via a mobile phone. An SMS format message can comprise a maximum of 160 alphanumeric characters. The programs are developed and implemented using a set of software tools known as the SIM TOOLKIT, resulting from the standardization work of the ETSI/SMG9 and described in GSM recommendations 11.11 phase 2+and 11.14 phase 2+.

FIG. 3 is a flowchart showing steps of a delivery mode of a method of the invention of managing a proof of reservation. This figure symbolizes on the left-hand side the steps executed on the customer C side and on the right-hand side the steps executed on the RMU side.

The process begins with a step 100 executed on the customer C side to generate information defining a request to make a reservation for a journey. It then includes a step 200 executed on the RMU side for receiving a reservation request message containing the information defining the journey reservation request. It then includes a step 300 executed on the RMU side for sending the mobile phone MP of the customer C a reservation confirmation message that contains reservation information relating to the journey for which a reservation has been made. Finally, it includes a step 400 executed on the customer C side for storing the reservation information received in the memory MEM of the mobile phone MP with the reservation confirmation message previously cited. The function of the reservation information stored in the memory MEM of the mobile phone MP in this way is to serve as proof of the reservation. To prevent fraud, the information can include a confidential code and/or can be encoded.

In one example corresponding to the diagram of FIG. 1a, the step 100 of generating a request to make a reservation for a journey is effected by way of an oral conversation between an agent A1 of the provider and the customer C. In this example, the customer C goes to a ticket window of the provider or a travel agent, an employee of a travel agent being here regarded as equivalent to the agent A1 of the provider. To execute step 100, the customer C explains to the agent A1 the characteristics of the journey he wishes to make (referred to hereinafter as the required journey). For example, these characteristics relate to the approximate departure date and time required, a preference for first or second class, smoking or non-smoking, etc. The agent A1 then consults a database stored in the RMU using a computer terminal CT such as a computer connected to the RMU via an appropriate telecommunications network. The database contains information relating to the availability of the journeys offered by the provider. As a function of this information, which the agent A1 can communicate orally to the customer C, and after an oral exchange between the agent A1 and the customer C, information is Generated defining a request to make a reservation for a journey that is referred to hereinafter as the offered journey and is a journey that is available and matches as closely as possible the required journey. The expression “matches as closely as possible” employed above expresses the fact that the characteristics of the offered journey are the best possible match to the characteristics of the required journey. The offered journey can differ from the required journey in more or less important ways relating to the characteristics of the journey, for example departure or arrival time, level of comfort, smoking or non-smoking, etc.

A request to make a reservation for the offered journey, for example in the form of an SMS format message, is then generated and sent to the reservation management unit from the computer terminal CT of the agent A1 and via the telecommunications network mentioned above. The reservation request message is then received by the RMU in the step 200. Note that it follows from the foregoing description that the reservation request relates to a journey offered by the provider that is necessarily still available.

In another example, conforming to the diagram of FIG. 1b, the step 100 of generating information defining the journey reservation request is carried out without going to a ticket window of the travel company or a travel agent, for example by the customer C himself, using his mobile phone MP.

In a first variant, the customer C uses his mobile phone to communicate with a telephone operator taking the role of the agent A1 in FIG. 1a. The reservation request is again generated by way of an oral conversation (here a telephone conversation) between the customer C and an agent of the provider. However, unlike the FIG. 1a example, the reservation request is sent to the RMU from the mobile phone MP of the customer C. The message is an SMS format message, for example.

In a second variant, the customer C visits the Internet site of the provider via his mobile phone (the pages of the Internet site are transmitted using the Wireless Application Protocol (WAP) web page description language). This enables him to find out the journeys that are still available that are close to the required journey. The customer C then generates a reservation request which is then sent to the RMU from the mobile phone MP, for example in the form of an SMS format message.

In another, final, example, conforming to the FIG. 1c diagram, step 100 is carried out via the Internet from the home of the customer C using a personal computer PC. This example is not unlike the second variant of the preceding example. The customer C visits the Internet site of the provider, but this time via his personal computer (the pages of the internet site are transmitted in the Hypertext Markup Language (HTML)). The reservation request can then be sent to the RMU from the personal computer, again in the form of an SMS format message, for example.

In the second variant of the second example and in the third example in particular, although not exclusively, step 100 includes the substeps shown in the flowchart of FIG. 4. This figure shows diagrammatically on the left-hand side the substeps executed on the customer C side and on the right-hand side the substeps executed on the RMU side.

In a first substep 101 executed on the RMU side, the RMU receives a reservation request message containing information defining a required journey. This is an SMS format message, for example, which can be sent from the mobile phone MP of the customers C (FIG. 1b) or his personal computer PC (FIG. 1c). The characteristics of the required journey, which are encoded in the above information, are, for example, entered by the customer C on the keyboard KB of his mobile phone MP (FIG. 1b) or his personal computer (FIG. 1c) by filling in at least some of the data entry fields of a data entry blank displayed on the screen SCR of the mobile phone MP or of the personal computer PC, respectively. As is known in the art, this kind of operation can be performed by an ad hoc program running in the mobile phone MP or on the personal computer PC, respectively. In the former case, the program can be stored in a SIM card coupled to the mobile phone MP (see FIG. 2). The required reservation message containing the information defining the required journey is then received by the RMU.

In a variant, substep 101 entails mailing a reservation suggested by the travel company in the form of a paper document. When received by the travel company, the document is treated as a required reservation.

In a second substep 102, executed on the RMU side, reservation offer information defining an offered journey is produced. The offered journey is that matching as closely as possible the required journey. The reservation offer information is produced from required reservation information received in the required reservation message and availability information relating to the availability of the journeys offered by the provider. The availability information for journeys offered by the provider is read from a database in the RMU, for example. Substep 102 is executed by an ad hoc program running in the RMU.

In a third substep 103, executed on the RMU side, the RMU sends a reservation offer message containing the reservation offer information previously cited to the mobile phone MP of the customer C, for example. The reservation offer message that is sent in substep 103 is an SMS format message sent from the RMU to the mobile phone MP (FIG. 1b) or to the personal computer PC (FIG. 1c) of the customer C, for example.

In a fourth and final substep 104, executed on the customer side, the reservation request is generated from the reservation offer information received in the reservation offer message sent in substep 103. In practice, the information defining the journey reservation request corresponds to the characteristics of the offered journey. In other words, the sending to the RMU from the mobile phone MP (FIG. 1b) or the personal computer PC (FIG. 1c) of the customer C of a reservation request message containing information corresponding to the reservation offer information is equivalent to the customer making a reservation for the offered journey. The customer C then has two options: either to accept or to refuse to make the reservation for the offered journey.

The reservation request information sent in the reservation request message preferably includes data identifying the customer C. Such data includes, for example, the name of the customer, a customer number, the number of his mobile phone, and/or any information serving to identify the customer relative to other customers of the provider. This information identifying the customer C can equally be contained in the information defining the required journey that is sent with the required reservation message in substep 101 (see FIG. 4). For example, this allows for managing specific services that the provider can offer to particular customers, for example a reduction in the cost of a journey, preference or priority for providing a journey having particular characteristics to particular preferred customers, etc.

The reservation information sent by the RMU in step 300 with the reservation confirmation message preferably contains data identifying the reserved journey and/or the data referred to in the previous paragraph identifying the customer C. This enables subsequent checking of the proof of the reservation for the journey, which consists of this reservation information in the memory MEM of the mobile phone MP of the customer C. This checking is performed in a checking mode of the management method of the invention, to be described later.

In one example, the reservation request information received by the RMU with the reservation request message in step 200 includes data for paying the price of the journey. This kind of data includes the number of the customer's bank card, for example, or any other information that can be transmitted in a secure manner, to enable the debiting of a bank account of the customer C to pay for the reserved journey. In one example, the reservation confirmation message is sent in step 300 only if the data for paying the price of the journey received in step 200 is valid, i.e. if it enables valid payment of the price of the reserved journey. The validity of the payment is conditional on the reception by the RMU of validation information sent by a banking network, for example (in France) the Carte Bleue interbank system network.

The information on the availability of the reserved journey is also updated in the database of the RMU in step 300, to mark the reserved journey as not available. This enables efficient management of the database, avoiding the same journey being assigned to two different customers.

The data mentioned above identifying the customer is preferably integrated into the availability data for the journey that is updated in the database of the RMU. This enables tracking of reserved journeys for subsequent checking of the proof of the reservation (see below, in the description of the second aspect of the invention). However, this also makes it possible to offer customers complementary services, subsequently to making a reservation. In particular, this makes it possible to contact the customer C afterwards to offer a modified reservation that is a better match to the requirement stated by the customer when making the original reservation, and which could not be satisfied then because the required journey was not available.

This is why, in a preferred embodiment, the required reservation information that is received by the RMU with the reservation request message in substep 101 (see FIG. 3) is stored in a queue of a memory of the RMU if the offered journey is not identical to the required journey, for example because the required journey is not available. The method of the invention of issuing a proof of reservation then advantageously includes a substitution mode, enabling the customer to substitute a journey closer to the required journey for the journey originally reserved. This mode includes the steps shown diagrammatically in the flowchart of FIG. 4. This figure shows symbolically on the left-hand side the steps that are executed on the customer C side and on the right-hand side the steps that are executed on the RMU side.

The first step 500 is executed on the RMU side and consists in the RMU sending the mobile phone MP of the customer C a modified reservation offer message containing information defining a reservation offer for a different journey, referred to hereinafter as the modified journey, that is identical to the required journey or at least approximates more closely the required journey than the journey originally reserved. The modified reservation offer message can further include some or all of the reservation information corresponding to the journey originally reserved, so that the user can tell clearly which journey originally reserved it is proposed to replace with the modified journey. This message is an SMS format message, for example. The user can consult the information contained in the modified reservation offer message on the screen of his mobile phone MP, for example.

In a step 600 executed on the customer C side a message accepting the modified reservation offer is sent to the RMU from the mobile phone MP of the customer C. This is again an SMS format message, for example.

Sending this message accepting the modified reservation offer leads to a step 700 executed on the customer C side of corresponding updating of the reservation information in the memory of the mobile phone MP of the customer C. This updating consists in replacing the data in the reservation information identifying the journey originally reserved with data identifying the modified journey extracted from the information defining the modified journey reservation offer. Stated otherwise, the modified journey replaces the journey originally reserved, and the proof of the reservation, consisting of the reservation information stored in the memory of the mobile phone of the customer, is corrected accordingly. In parallel with this, a step 800 of correspondingly updating the journey availability information in the database of the RMU is executed on the RMU side. This enables marking of the journey originally reserved as available again and, conversely, marking the modified journey as not available.

FIG. 6 shows the steps of a cancellation mode of the management method of the invention. In this figure also, the steps executed on the customer C side are shown on the left-hand side and those executed on the RMU side are shown on the right-hand side. In a step 1000 executed on the customer C side the journey previously reserved that is to be canceled is selected. More than one journey might have been reserved at any given time, in which case all the corresponding reservation data is saved in the memory MEM of the mobile phone MP. The customer C selects the journey for which the reservation is to be canceled, for example using a pull-down menu displayed on the screen SCR of his mobile phone MP, after reading the reservation data in the memory MEM.

In a step 2000, the RMU receives a cancellation message from the mobile phone MP of the customer C. This is an SMS format message, for example. It contains cancellation data identifying in particular the journey for which the reservation is to be canceled. The data can consist of a reservation number assigned at the time of making the reservation and saved with the reservation data in the memory MEM of the mobile phone MP.

In a step 3000, the RMU cancels the reservation by marking the journey canceled as available again in the database of the RMU. Stated otherwise, the availability information for the journey is returned to the state prevailing before the reservation was made.

In a step 4000, the RMU generates and sends a message confirming cancellation of the reservation. This is an SMS format message, for example. This message can again contain the reservation number previously cited, to identify the journey concerned. This message is received by the mobile phone MP of the customer C.

Finally, in a step 5000 executed on the customer C side on receiving the message confirming the cancellation sent in step 4000 by the RMU, the reservation information relating to the journey for which the reservation has been canceled is deleted from the memory MEM of the mobile phone MP. Stated otherwise, the reservation information saved in the memory MEM of the mobile phone MP of the customer C is updated to take account of the cancellation of the reservation for the journey concerned.

The management method of the invention can also include a modification mode. This mode includes steps for modifying the characteristics of a reserved journey at the initiative of the customer C. In practice, such modification amounts to canceling the reservation for the journey originally reserved and making a reservation for a new journey. The modification mode therefore in fact corresponds to a combination of the cancellation mode and the reservation mode described above.

FIG. 7, in which items also shown in FIGS. 1a to 1c bear the same reference numbers as in those figures, is a diagram of the system for implementing the checking mode of the method of the invention of managing a proof of reservation.

The system includes, in addition to the RMU and the mobile phone MP of a customer C, a checking terminal T of an agent of the provider, referred to hereinafter as the checking agent A2. Note that the RMU can be at a great distance from the terminal T when the checking mode is being used. The reservation information relating to a reserved journey was stored in the memory MEM of the mobile phone MP of the customer C using the delivery mode and possibly the substitution mode for substituting a proof for a journey, as described previously with reference to FIGS. 3 to 5.

The diagram of FIG. 8 shows a simplified example of the structure of the terminal T. The terminal T includes a central processor unit CPU such as a microprocessor or a microcontroller. It further includes a memory MEM2 such as an integrated circuit memory, either a volatile memory (DRAM or SDRAM, for example) or a non-volatile memory (EEPROM or Flash-EPROM, for example). It can equally well be a removable memory, such as a digital optical disc (CD-ROM). The terminal T further includes a screen SCR2 and possibly a keyboard KB2 or the like, forming a man/machine interface. The memory MEM2, the keyboard KB2 and the screen SCR2 can be connected to the CPU by an appropriate data bus DB. The terminal T also includes communications means COM1, such as a radio frequency interface, enabling it to exchange data remotely with the RMU. Alternatively, a RS-232 interface enables the terminal T to be physically connected to the RMU or to an intermediate unit for receiving data from the RMU.

The system further includes means for implementing the checking mode of the management method. In the checking mode the method includes the steps shown in the flowchart FIG. 9. The means for implementing the checking mode of the management method take the form of a program stored in the memory MEM2 of the terminal T and running in the central processor unit CPU of the terminal T, for example, and/or a program stored in the memory MEM of the mobile phone MP of the customer C and running in said mobile phone.

FIG. 9 shows symbolically on the left-hand side the steps of the method that are executed on the terminal T side and on the right-hand side the steps of the method that are executed on the RMU side.

A first step 10 executed on the RMU side in a preparatory phase consists in the RMU sending the terminal T availability information associated with a reserved journey using the communications means COM1 of the terminal T. The step 10 is symbolized in FIG. 5 by an arrow 10. In one example, the availability information sent in this way to the terminal T consists of the availability data relating to all of the journeys offered by the provider for a particular train and that have been reserved up to the departure time of the train. Thus the step 10 is executed just before the departure of the train, for example, at the moment when the checking agent A2 boards the train to begin checking tickets. The sending of the availability information can be commanded by a program running in the RMU, either automatically or (and preferably) in response to a command sent from the terminal T via the communications means COM1. In the event of poor reception of the availability information or subsequent loss of the data, the checking agent A2 can call for some or all of the availability data to be sent again.

Still in the preparatory phase, a step 20 executed on the checking agent A2 side then stores the availability information received by the terminal T in the memory MEM2 of the terminal T.

Stated otherwise, the steps 10 and 20 consist in downloading at least part of the RMU database into the memory MEM2 of the terminal T.

In a checking phase, a step 30 executed on the checking agent A2 side when the checking agent A2 is with a customer C seated in a given seat on the train asks the passenger to prove his reservation for the journey corresponding to the seat he is occupying. This step consists in comparing the availability information stored in the terminal T to reservation information relating to a reserved journey that is stored in the memory MEM of the mobile phone MP of the customer C or to data identifying the customer.

In the former case, the reservation information is read in the memory MEM of the mobile phone MP and displayed on the screen SCR of the mobile phone MP under the control of a program stored in the memory MEM of the mobile phone MP and running in said mobile phone MP. The checking agent A2 can then consult this information visually on the screen SCR and compare it with the availability information read from the memory MEM2 of his terminal T and displayed on the screen SCR2 of the terminal T.

Alternatively, the memory MEM of the mobile phone MP is a removable memory that can be coupled to the mobile phone MP and to the terminal T, such as the memory in a smart card, for example the smart card SM described above with reference to FIG. 2 (which is a SIM card). The terminal T then further includes reading means for reading reservation information in said removable memory MEM when the latter is coupled to the terminal T and comparator means for comparing the reservation information to the availability information read from the memory MEM2 of the terminal T. The comparison is then automatic from the point of view of the checking agent A2, since the step 30 is executed by decoupling the removable memory MEM from the mobile phone MP and coupling it to the terminal T before running an appropriate program in the terminal T.

In a variant of this procedure, the reservation information is read in the memory MEM of the mobile phone MP and sent to the terminal T via a short-range radio-frequency link, for example, such as a Blue Tooth link, and under the control of a program stored in the memory MEM of the mobile phone MP and running in said mobile phone ME. The terminal then includes appropriate communications means COM2, such as a Blue Tooth interface.

In some cases, and especially if the mobile phone MP of the customer C is faulty or the customer has forgotten to bring his mobile phone with him, the comparison step 30 is executed by the checking agent A2, who compares the availability information stored in the memory MEM2 of the terminal T to the data identifying the customer C, such as his name. One advantage of the invention is that the availability information available to the checking agent A2 in the memory MEM2 of the terminal T can include this kind of identification data. The customer C can then be asked for his passport or any other document attesting to his identity.

1. A method of managing proof of reservation of a product or a service by a given customer (C), the method consisting in processing reservation information relating to said reserved product or service in a memory (MEM) of a communicating portable object (MP) of the customer (C) which includes communications means for exchanging messages with a reservation management unit (RMU), said reservation information serving as proof of the reservation, the method comprising successively, in a delivery mode, the steps of:
a) producing (100) information defining a request to reserve a product or service;
b) the reservation management unit (RMU) receiving (200) a reservation request message containing said information defining the reservation request in respect of the product or service;
c) the reservation management unit (RMU) sending (300) the portable object (MP) of the customer (C) a message confirming the reservation and containing reservation information relating to the reserved product or service; and
d) storing (400) said reservation information in the memory (MEM) of the portable object (MP) of the customer (C) to serve as proof of the reservation.

2. A method according to claim 1, wherein step a) is carried out by means of a conversation between an agent (A1) of a provider of the product or service and the customer (C).

3. A method according to claim 2, wherein the reservation request message received in step b) is sent from a data processing terminal (CT) of the agent (A1) of the provider of the product or service via a telecommunications network.

4. A method according to claim 2, wherein the conversation between the agent (A1) of the provider and the customer (C) takes place by telephone and the reservation request message received in step b) is sent from the portable object (MP) of the customer (C).

5. A method according to claim 1, wherein step a) is carried out by the customer visiting an Internet site of the provider by means of his portable object (MP) or a personal computer (PC) and the reservation request message received in step b) is sent via the Internet from the portable object (MP) or from the personal computer (PC), respectively.

6. A method according to claim 1, wherein step a) includes the following substeps:
a1) the reservation management unit (RMU) receiving (101) a required reservation message containing reservation request information defining a required product or service;
a2) the reservation management unit (RMU) producing (102), from required reservation information and from availability information relating to the availability of the products or services offered by the provider, reservation offer information defining an offered product or service that is as close as possible to the required product or service;
a3) the reservation management unit (PMU) sending (103) a reservation offer message containing said reservation offer information; and
a4) generating (104) the reservation request from the reservation offer information.

7. A method according to claim 6, wherein the required reservation message received in step a1) and/or the reservation request message received in step b) are sent from the portable object (MP) of the customer (C) and the reservation offer message sent in step a3) is sent to the portable object of the customer.

8. A method according to claim 6, wherein the required reservation message received in step a1) and/or the reservation request message received in step b) are sent from the personal computer (PC) of the customer (C) and the reservation offer message sent in step a3) is sent to the personal computer of the customer.

9. A method according to any one of claims 1 to 8, wherein the reservation request information contains data identifying the customer (C).

10. A method according to claim 9, wherein the reservation information contains data identifying the reserved product or service and the data identifying the customer (C).

11. A method according to any one of claims 1 to 10, wherein the reservation request information received in step b) contains data for paying the price of the product or the service.

12. A method according to claim 11, wherein the reservation confirmation message is sent in step c) only if the data for paying the price of the product or the service received in step b) is valid.

13. A method according to any one of claims 6 to 12, wherein the information on the availability of the product or service is read in step a2) in a database of the reservation management unit (RMU).

14. A method according to claim 13, wherein the information on the availability of the reserved product or service is updated in the database in step c) to mark the reserved product or service as unavailable.

15. A method according to claim 9 and claim 14, wherein the data identifying the customer (C) is integrated in step c) into the updated information on the availability of the product or the service.

16. A method according to any one of claims 6 to 15, wherein the required reservation information is stored in a queue of a memory of the reservation management unit (RMU) if the reservation offered does not correspond to the required reservation because of the non-availability of the required product or service.

17. A method according to claim 16, further including, in a substitution mode, the steps of:
e) the reservation management unit (RMU) sending (500) the portable object (MP) of the customer (C) a modified reservation offer message containing information defining an offer for the reservation of a modified product or service identical to the required product or service or at least matching the required product or service more closely than the reserved product or service;
f) the portable object (MP) sending (600) the reservation management unit a message accepting the modified reservation offer;
g) correspondingly updating (700) the reservation information in the memory of the portable object (MP) of the customer (C); and
h) correspondingly updating (800) the availability information on the products or services in the database of the reservation management unit (RMU).

18. A method according to any preceding claim including, in a cancellation mode, the steps of:
i) selecting (1000) the product or service whose reservation is to be canceled on the basis of reservation information stored in the memory (MEM) of the portable object (MP) of the customer (C);
j) the reservation management unit (RMU) receiving (2000) a message advising cancellation of said product or service;
k) correspondingly updating (3000) the availability information for the products or services in the database of the reservation management unit (RMU); and
l) correspondingly updating (500) the reservation information in the memory (MEM) of the portable object (MP) of the customer (C).

19. A method according to any preceding claim, wherein the reservation request message, the required reservation message, the reservation offer message, the reservation confirmation message, the modified reservation offer message, the modified reservation offer acceptance message, the cancellation message, and/or the cancellation confirmation message is/are an SMS format message.

20. A method according to any preceding claim including, in a checking mode, the steps of:
m) in a preparatory phase, the reservation management unit (RMU) sending (10) a checking terminal (T) availability information relating to a reserved product or service, which information is stored (20) in a memory (MEM2) of said checking terminal (T); and
n) in a checking phase, comparing (20) the availability information stored in the memory (MEM) of the checking terminal (T) to reservation information relating to a reserved product or service stored in the memory (MEM) of the portable object (MP) of a customer (C) or to data identifying a customer (C).

21. A method according to claim 20, wherein the reservation data is displayed on a screen of the portable object (MP) of the customer (C) in the step n) so that it can be viewed by a checking agent (A2) of the provider of the product or service.

22. A method according to claim 21, wherein the reservation data is stored in a removable memory that can be coupled to the portable object (MP) of the customer (C) and to the checking terminal (T) and said removable memory is coupled to the checking terminal (T) in step b) so that it can be read by the checking terminal (T).

23. A system for implementing a method according to any one of claims 1 to 22, said system comprising:
a reservation management unit (RMU), and
a communicating portable object (MP) of a customer (C) having a memory (MEM) and communications means for exchanging messages with the reservation management unit (RMU).

24. A system according to claim 23, wherein the memory (MEM) of the portable object (MP) is removable.

25. A system according to claim 24, wherein the memory (MEM) of the portable object (MP) is a smart card.

26. A system according to claim 25, wherein the memory (MEM) of the portable object (MP) is a SIM card.

27. A system according to any one of claims 23 to 26, wherein the communications means of the portable object (MP) include an SMS interface for exchanging SMS format messages with the reservation management unit (RMU).

28. A system according to any one of claims 23 to 27, in particular for implementing a method according to any one of claims 20 to 22, further including a checking terminal (T) having:
a memory (MEM2), and
first communications means (COM1) for exchanging messages with the reservation management unit (RMU).

29. A system according to claim 24 and claim 28, wherein the memory (MEM) of the portable object (MP) of the customer (C) is a removable memory that can be coupled to the portable object (MP) and to the checking terminal (T).

30. A system according to claim 28 or claim 29, where in said first communications means (COM1) of the checking terminal (T) comprise an SMS interface for exchanging SMS format messages with the reservation management unit (RMU).

31. A system according to any one of claims 28 to 30, wherein the checking terminal (T) further includes second communications means (COM2) for exchanging information with the portable object (MP) of the customer (C).

32. A system according to claim 31, wherein said second communications means include a short-range radio connection interface.

33. A portable object (MP) as defined in any one of claims 23 to 32.

34. A checking terminal (T) as defined in any one of claims 28 to 32.
